(19) United States
(12) Patent Application Publication
(10) Pub. No.: US 2017/0132618 A1
(43) Pub. Date: May 11, 2017

(54) MOBILE CARD SERVICE METHOD UTILIZING HCE, AND MOBILE TERMINAL APPLYING SAME

(71) Applicant: MOZIDO CORFIRE - KOREA, LTD., Seoul (KR)

(72) Inventor: Hyung Joon HONG, Gyeonggi-do (KR)

(21) Appl. No.: 15/306,263

(22) PCT Filed: Apr. 27, 2015
(86) PCT No.: PCT/KR2015/004163

§ 371 Date: Jan. 26, 2017

(30) Foreign Application Priority Data
Apr. 25, 2014 (KR) 10-2014-0050087

(51) Int. Cl. G06Q 20/38; G06Q 20/32; G06Q 20/40

(52) U.S. Cl. CPC G06Q 20/3829; G06Q 20/401; G06Q 20/32

(57) ABSTRACT

A mobile card service method utilizing an HCE, and a mobile terminal applying the same are provided. A mobile card service method according to an embodiment of the present invention comprises: receiving mobile card information in which a monetary value can be stored; and storing the mobile card information in a storage place of a mobile terminal using a card emulation function provided by an OS of the mobile terminal. Accordingly, a mobile card can be securely stored in the mobile terminal even without a separate SE.

### TECHNICAL FIELD

The present invention relates to a mobile service, and more particularly, the present invention relates to a mobile SVC service which issues a mobile SVC (Stored Value Card) and the issued mobile SVC is used for mobile payment, etc.

### BACKGROUND ART

Presently, a mobile SVC is issued with the SVC serial number via a Short Message Service (SMS). As such, of the SMS message is deleted unintentionally, the SVC becomes invalid. In addition, a lost mobile terminal can be used by a third party maliciously.

In addition to the loss of a mobile terminal, there are still possibilities of abuse or misappropriation. This is because the serial No. included in the SMS message or the SMS message itself can be acquired and utilized by a malicious third party.

To this end, there arises a demand for a method for storing and using a mobile SVC more safely in a mobile terminal.

### DETAILED DESCRIPTION OF THE INVENTION

### Technical Objects

An aspect of the present invention devised to solve above described problems is to provide a method for mobile SVC service which enables storing a received mobile SVC safely in a mobile terminal using a Host Card Emulation (HCE) function provided by an Operating Service (OS) of a mobile terminal, and a mobile terminal implementing the same.

In addition, another aspect of the present invention is to provide a method for a mobile SVC service wherein the information on the mobile SVC stored in a mobile terminal cannot be identified and the information is safe from being exposed to a third party in the course of utilizing the information.

### Means for Achieving the Technical Object

A method for achieving above objectives in accordance with an embodiment of the present invention comprises the steps of: receiving mobile card information which enables storing monetary value; and saving the mobile card information in the storage device of a mobile terminal using a card emulation functionality provided by an Operating System (OS) of the mobile terminal.

In addition, the card emulation function can be a function provided by the OS of the mobile terminal without physical secure element (SE).

In addition, the mobile card information can include any one of a private key and public key necessary for using the mobile card.

In addition, the private key and public key can be generated using a user information.

In addition, the user information can be stored in the SE of the mobile terminal.

In addition, the private key and public key included in the mobile card information can be generated by a mobile card server which can keep the public key but not the private key.

In addition, the method for mobile card service in accordance with an embodiment of the present invention can further comprise the step of requesting use of the mobile card using the mobile card information stored in the memory device of the mobile terminal with the card emulation functionality provided by the OS of the mobile terminal.

In addition, the use of the mobile card can include at least one of transferring a whole or a portion of a balance of the mobile card to a third party and mobile payment with the balance of the mobile card.

In addition, the saving step can save an encoded mobile card information.

In addition, the saving step can encode the mobile card information using a password entered by a user.

In addition, the mobile card can include at least one of a mobile SVC, a mobile stored value account (SVA) card, a mobile prepaid card, a mobile gift card, and a mobile traffic card.

Meanwhile, a mobile terminal in accordance with another embodiment of the present invention comprises: a communication unit for receiving ‘a mobile card information for storing a monetary value’, a storage device for storing a mobile card information; and a processor for saving the mobile card information received via the communication unit in the storage device using a card emulation functionality provided by an Operating System (OS) of a mobile terminal.

In addition, the method for mobile card service in accordance with another embodiment of the present invention comprises the step of: acquiring a mobile card information for storing a monetary value stored in the storage device of the mobile terminal using the card emulation functionality provided by the OS of the mobile terminal; and requesting a use of the mobile card using the mobile card information acquired in the acquiring step.

In addition, the mobile card information can include a private key, and the step of requesting use of the mobile card can request use of the mobile card while transferring a payment information encoded with the private key.

In addition, the use of the mobile card can include at least one of transferring a whole or a portion of a balance of the mobile card to a third party and mobile payment with the balance of the mobile card.

Meanwhile, a method for mobile card service in accordance with another embodiment of the present invention comprises the steps of: generating ‘a mobile card information for storing a monetary value’, and transferring the mobile card information generated in the above generation step; wherein the mobile terminal saves the mobile card information in the storage device of the mobile terminal using the card emulation functionality provided by the OS of the mobile terminal.

In addition, a method for mobile card service in accordance with still another embodiment of the present invention can comprise the steps of: saving only the public key of the public and private keys.

In addition, a method for mobile card service in accordance with still another embodiment of the present invention can further comprise the steps of: receiving a request for using the mobile card while receiving from the user terminal the information encoded with the private key; decoding the encoded information using the public key; and processing the use of the mobile card using the decoded information.

Meanwhile, a server for mobile card service in accordance with another embodiment of the present invention can comprise: an authorization unit for generating a ‘mobile card information for storing a monetary value’, and an issuing unit for transferring the mobile card information generated in the above authorization unit to a mobile terminal; wherein the mobile terminal can save the mobile card information in the storage device of the mobile terminal using the card emulation functionality provided by the OS of the mobile terminal.

Meanwhile, a method for mobile card service in accordance with another embodiment of the present invention comprises the steps of: receiving a request for payment including a payment information generated using the ‘mobile card information which can store a monetary value’, decoding the payment information included in the payment request; and processing the payment with the decoded information for payment.

In addition, the mobile card information can include a private key, the information for payment is encoded with the private key, and the decoding step can decode the information for payment using a public key which forms a pair with the private key.

In addition, the payment processing step can comprise the steps of: determining whether the balance of the mobile card is equal to or greater than the amount of payment indicated in the information for payment; if the balance is more than the amount of payment, checking the limitations imposed on the mobile card; and if the mobile card is not subject to above limitation, deducting the amount of payment from the balance.

In addition, the limitations can include at least one of the maximum limit of payment, validity term and count of payment of the mobile card.

### Effect of the Invention

As described above, the embodiments in accordance with the present invention can store mobile SVC safely in a mobile terminal without an additional SE, by storing the issued mobile SVC in the mobile terminal using the HCE functionality provided by the OS of the mobile terminal to prevent exposure of the related information.

In addition, the embodiments of the present invention hays an advantage that the information is not disclosed to the outside in the process of using an mobile SVC.

### BRIEF DESCRIPTION OF THE DRAWING

FIG. 1 is a schematic diagram illustrating an SVC service system to which an embodiment in accordance with the present invention can be applied,

FIG. 2 is a diagram illustrating a structure of a database of the SVC server,

FIG. 3 is a flow chart describing the process of issuing a new mobile SVC,

FIG. 4 is a flow chart showing the process of money transfer of a mobile SVC,

FIG. 5 and FIG. 6 are flow charts showing a process of offline payment using the mobile SVC,

FIG. 7 is a flow chart showing a process of online payment using the mobile SVC,

FIG. 8 is a flow chart showing a process of storing a key pair by applying PBE, and

FIG. 9 is a detailed flow chart of the step S640 of FIG. 6 and step S790 of FIG. 7.

### PREFERABLE EMBODIMENT OF THE INVENTION

The present invention is described in further details below by referring to accompanying drawings.

1. SVC Service System

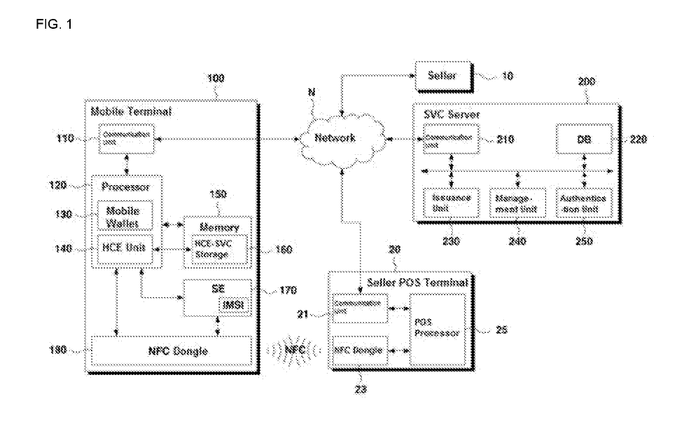

FIG. 1 is a schematic diagram illustrating an SVC (Stored Value Card) service system to which an embodiment in accordance with the present invention can be applied. An SVC service system to which an embodiment of the present invention can be implemented, as shown in FIG. 1, comprises a mobile terminal 100, an SVC server 200, a seller 10, and a seller's terminal 20 for point of service (POS).

The SVC server 200 issues a mobile SVC to a mobile terminal 100, controls the information of the issued mobile SVC, process use of mobile SVC, and providing a mobile SVC.

Use of mobile SVC can be broadly classified into money transfer and payment. Money transfer refers to transferring a whole and portion of the balance of the mobile SVC of a transferer to a mobile SVC of a transferee. Payment refers to transferring the amount of money claimed by a seller from the mobile SVC of a buyer and can be classified into online payment and offline payment.

The mobile terminal 100 receives the mobile SVC issued by the SVC server 200 and stores it securely using the host card emulation (HCE) functionality provided by the operating system (OS). In addition, the mobile terminal 100 can make use of the received mobile SVC by interacting with the SVC server 200, seller 10 and seller POS terminal 20.

The seller 10 refers to a terminal and/or server owned by a seller. The seller 10 manages online and offline commercial transactions and linked with the POS terminal 20 for offline transactions.

2. Mobile Terminal

As shown in FIG. 1, the mobile terminal 100 comprises: a communication unit 110, a processor 120, a mobile wallet 130, an HCE unit 140, a memory 150, an HCE-SVC storage 160, an SE (Secure Element) (170), and a Near Field Communication (NFC) module 180.

The communication unit 110 supports communication with the mobile terminal 100, ‘SVC server 200 and seller 10’ by accessing a network N.

The processor 120 controls overall behavior of the mobile terminal 100 and executes a mobile wallet application (hereinafter, shall be referred to as ‘mobile wallet) 130 and HCE unit 140 in relation with an embodiment in accordance with the present invention.

The mobile wallet 130 provides a user interface required for the issuance and use of the mobile SVC. When issuing the mobile SVC, the mobile wallet 130 marks a list of issuable mobile SVC in the mobile terminal 100, and when using the mobile SVC, the mobile wallet 130 marks a list of available mobile SVCs issued to the mobile terminal 100.

The mobile wallet 130, based on HCE, performs the process required for mobile SVC service in linkage with the HCE unit 140.

The HCE unit 140 which is a component included in the OS of the mobile terminal 100 enables HCE without a physical SE. More particularly, the HCE unit 140 stores the mobile SVC issued by the SVC server 200 in the HCE-SVC storage 160 of the memory 150.

The HCE-SVC storage 160 which is a specific domain of the memory 150 allocated for safe storage of the mobile SVC is named by “HCE-SVC storage” considering that it is a domain whose security is guaranteed by the HCE functionality of the OS and accessible only by the HCE unit 140.

The SE 170 is a storage medium storing International Mobile Subscriber Identity (IMSI), for example, SIM (Subscriber Identity Module), USIM (Universal Subscriber Identity Module), UICC (Universal IC Card), eSE (embedded Secure Element), and mSD card (micro Secure Digital Card), etc. The NFC module 180 is a means for executing NFC with the NFC dongle 23 of the seller's POS terminal 20.

3. SVC Server

As shown in FIG. 1, the SVC server 200 comprises a communication unit 210, a DB 220, an issue unit 230, an administration unit 240 and an authorization unit 250.

The communication unit 210 supports communication between the SVC server 200 and mobile terminal 100 and seller 10′ by accessing a network N.

The issue unit 230 issues a new mobile SVC to a user terminal 100, and the administration unit 240 performs life cycle (LC) control over the issued mobile SVC, including discarding, updating, locking, and unlocking.

In addition, the administration unit 240 processes the use of the mobile SVC issued to the user terminal 100 including transfer of money, payment, etc,

The authorization unit 250, based on IMSI of SE 170, generated a key pair (public key and private key). The key pair generated by the authorization unit 250 constitutes a part of the mobile SVC information, that is, a core part of the mobile SVC information.

In addition, the authorization unit 250 conducts user authentication of the mobile terminal 100 using a public key, and discards keys.

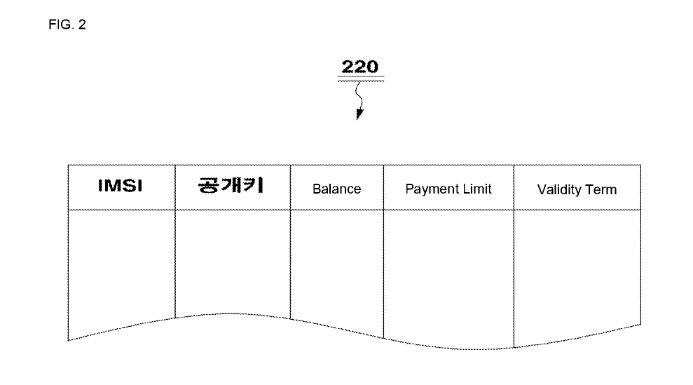

The DB 220 is a storage of the mobile SVC information. FIG. 2 illustrates the structure of the DB 220. As shown in FIG. 2, the DB 220 stores a public key, balance amount, payment limit, and validity term constituting the mobile card information, classified by IMSI unit.

The public key is generated by the authorization unit 250. For information, the DB 220 does not store a secret key. The payment limit and validity term are generated and determined by the issue unit 230, however, they are controlled and updated by the administration unit 240 afterwards.

Meanwhile, two or more mobile SVCs can be issued to one IMSI. For this, however, it is necessary that the ID/No. of a card intended to identify a mobile SVC to be added to the DB 220.

4. Seller POS Terminal

As shown in FIG. 1, the seller POS terminal 20 comprises a communication unit 21, an NFC dongle 23 and a POS processor 25.

The communication unit 21 supports communication between seller POS terminal 20 and seller 10 by accessing a network N. The NFC dongle 23 is a means for performing NFC with the NFC module 180 of the mobile terminal 100.

The POS processor 25 controls overall behavior of the seller POS terminal 20, and according to an embodiment of the present invention, transfers payment amount to the mobile terminal 100 via the NFC dongle 23 and receives the result of payment made by the SVC server 200 from the seller 10 through the communication unit 21.

5. New Issuance of a Mobile SVC

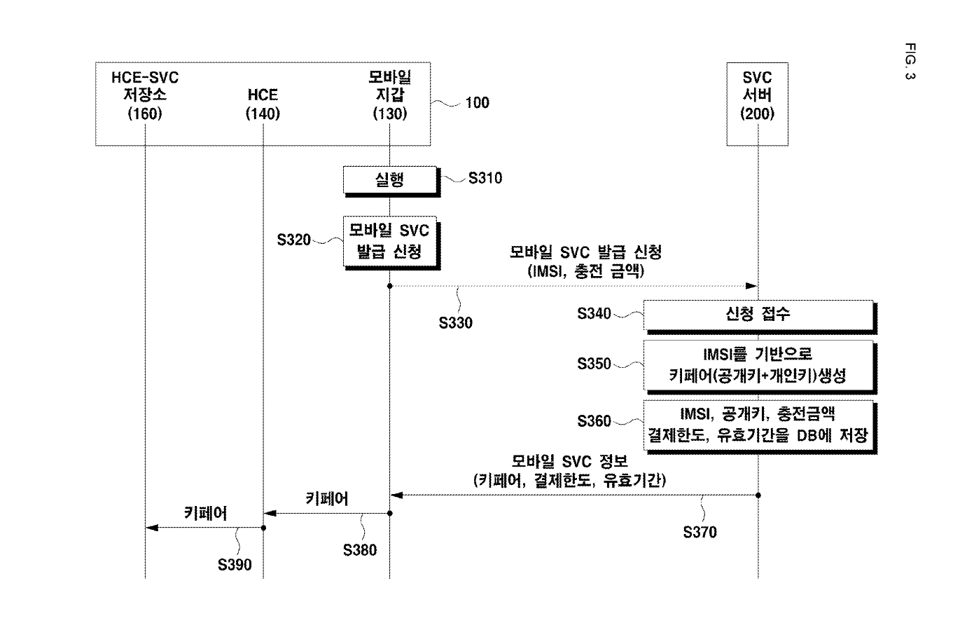

The procedure of the SVC server 200 issuing a new mobile SVC to a mobile terminal 100 on an online basis, is described by referring to accompanied FIG. 3. FIG. 3 is a flow chart describing the process of issuing a new mobile SVC.

As shown in FIG. 3, a user executes the mobile wallet 130 installed on the mobile terminal 100 (S310), and applies for issuing an SVC with the Add Card menu provided by the mobile wallet 130 (S320). When applying an SVC at the step S310, the user is requested to select/input an amount of money charging the card.

In the present embodiment, since the application for an SVC is made through the mobile wallet 130, if the mobile wallet 130 has not been installed on the mobile terminal 100, it is a prerequisite that the mobile wallet 130 be downloaded and installed before executing the step 310.

In the step S320, the mobile wallet 130 requests the SVC server 200 for issuing a mobile SVC according to the application of the user (S330). In the step S330, the application for the SVC sent from the mobile wallet 130 to the SVC server 200 includes IMSI and charge amount.

The IMSI is acquired from the SE 170 and the charge amount is determined by the selection or input from the user in the step S320.

The issue unit 230 of the SVC server 200 receives the application for mobile SVC in the step S330 (S340). In this step, the issue unit 230 can pre-process the payment of the user for the charge amount in linkage with a financial agency (not shown).

Next, the authentication unit 2500 of the SVC server 200 generates a key-pair (public key and private key) by substituting IMSI in a key generation algorithm (S350), and the issue unit 230 stores the IMSI, public key, balance (charged amount), payment limit (threshold), and term of validity in the DB 220 (S360).

In the step S360, only the public key of the key pair generated in the step S350 is stored in the DB 220. It should be noted that the secret key is not stored in the DB 220. In addition, the payment limit and term of validity are determined by the issue unit 230 in compliance with the policy of issuing the mobile SVC.

The threshold (payment limit) refers to a maximum amount of money that can be paid per transaction or per day and the term of validity is the validity term of the key pair generated in the step S350. As the core information of the mobile SVC is the key pair, the term of validity of the key pair is practically the term of validity of the mobile SVC. When the term of validity is expired, it is necessary to reissue or update the mobile SVC.

The generation of the mobile SVC by the SVC server 200 is substantially completed through the step S350 and step S360. The following procedure is to transfer the generated mobile SVC to the mobile terminal 100.

For this, the issue unit 230 transmits the mobile SVC information to the mobile wallet 130 (S370). The mobile SVC information includes a key pair (public key plus private key), payment limit and term of validity.

The mobile wallet 130 transmits the key pair included in the mobile SVC information received in the step S370 to the HCE unit 140 (S380), and the HCE unit 140 stores the received key pair in the HCE-SVC storage 160 of the memory 150 (S390).

The mobile SVC information (payment limit, term of validity) excluding the key pair, the mobile wallet 130 can be stored and controlled in the general area of the memory 150, not in the SVC storage 160. It would be obvious that these can also be stored and controlled in the HCE-SVC storage 160 together with the key pair by the HCE unit 140.

6. Money Transfer of Mobile SVC

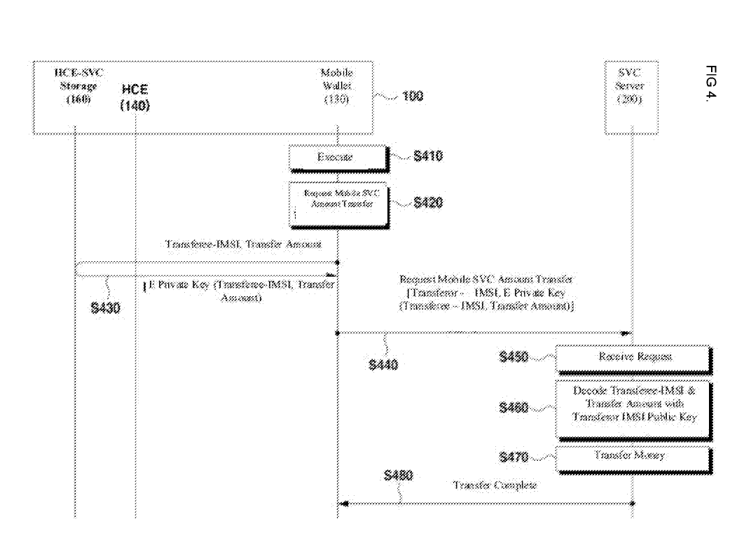

The procedures of SVC server 200 transferring whole or a portion of the balance of the mobile SVC by a request of a user (hereinafter, “transferer”) to another user (hereinafter, “transferee”) is described in detail by referring to FIG. 4. FIG. 4 is a flow chart showing the process of money transfer of a mobile SVC.

As shown in FIG. 4, a transferer executes the mobile wallet 130 installed on the mobile terminal 100 (S410), and applies for transferring an SVC money from the mobile wallet 130 (S420). When applying for an SVC money transfer at the step S430, the transferer is requested to input the IMSI of the transferee and amount of money to be transferred.

The mobile wallet 130 encodes transferee's IMSI and the amount of money to be transferred using the private key stored in the HCE-SVC storage 160 via the HCE unit 140 (S430). Then, the mobile wallet 130 sends a message including the encoded information, the transferer's IMSI and an application for money transfer to the SVC server 200 via the communication unit 110 (S440).

The SVC server 200 accepts the request for money transfer received at the step S440 (S450), extracts the public key matching the IMSI of the transferer recorded in the message requesting money transfer from the DB 220, and decodes the encoded IMSI of the transferee and amount of money (S460).

The step S460 also applies to the authentication procedure of the transferer. This is because, if the decoding at the step S460 were successful, it could be considered that the encoding had been performed using a fair private key, however, if the decoding were not successful, the encoding could not be considered to had been done with a fair private key.

If the decoding at the step S460 were successful, the SVC server 200 checks the balance, payment limit and term of validity of the transferer, and if they are all right, transfers the requested money (S470). The money transfer at the step S470 is carried out by deducting the amount from the balance of the transferer in the DB 220 and adding the amount to the balance of the transferee.

Then, the SVC server 200 sends a message notifying completion of money transfer to the mobile wallet 130 (S480).

In addition, the SVC server 200 can also send a message notifying completion of money transfer to the mobile wallet (not shown) installed in the mobile terminal (not shown) of the transferee so that the transferee can confirm the money transfer by executing the mobile wallet.

If the transferee is not a subscriber of the mobile SVC service, the step S470 cannot be carried out. In this case, the SVC server 200 may send the transferee an SMS (Short Message Service) which includes a URI (Uniform Resource Identifier) from where the transferee can download a mobile wallet to the mobile terminal of the transferee to recommend to install the mobile wallet and subscribe the service. When the software installation and subscription have been complete, the step S470 can be conducted.

7. Offline Settlement of Mobile SVC

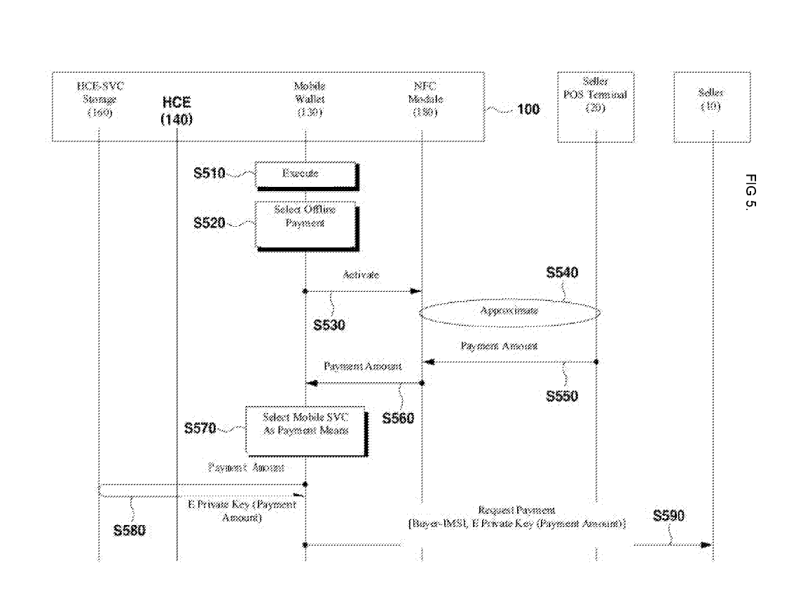

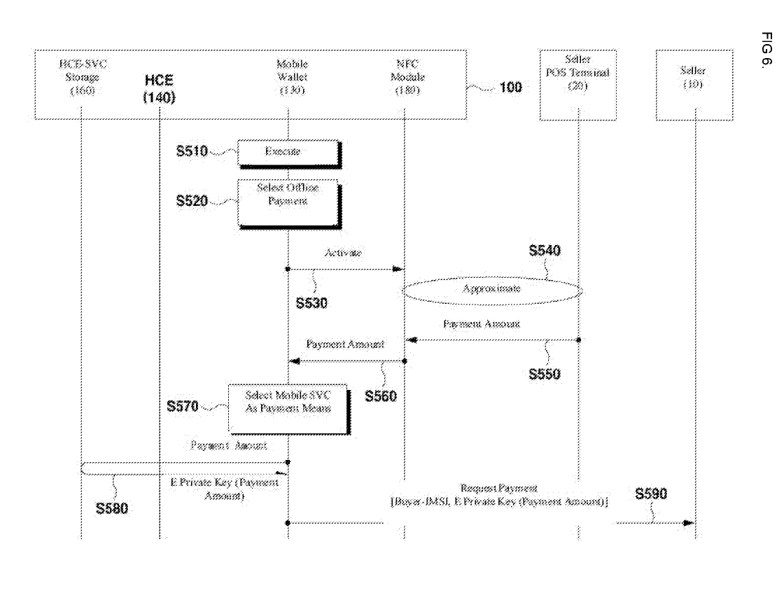

The procedure of offline settlement of the payment using the mobile SVC issued to the mobile terminal 100 is described in detail below by referring to FIGS. 5 and 6. FIGS. 5 and 6 are flow charts showing the process of offline settlement using the mobile SVC,

As shown in FIG. 5, a user (hereinafter, “buyer”) executes the mobile wallet 130 installed on the mobile terminal 100 (S510), and selects the offline settlement function provided by the mobile wallet 130 (S5s20).

Since the offline settlement function has been selected at the step S520, the mobile wallet 130 activates an NFC module 180 (S530), and requests the buyer to access his/her mobile terminal 100 to the NFC dongle 23 of the seller's POS terminal 20.

When the buyer accesses his/her mobile terminal 100 to the NFC dongle 23 (S540), the mobile wallet 130 receives the payment amount from the seller POS terminal 20 via the NFC module 180 (S550, S560).

Then, the buyer confirms the payment amount from the seller POS terminal 20 via the mobile wallet 130 and selects mobile SVC as a means for settlement (S570).

Then, the mobile wallet 130 encodes payment amount using the private key stored in the HCE-SVC storage 160 via the HCE unit 140 (S580). Then, the mobile wallet 130 sends a message requesting payment including the encoded payment amount and the buyer's IMSI to the seller 10 via the communication unit 110 (S590).

Meanwhile, the present invention can be also implemented to receive ‘URI of seller 101’ and ‘ID of seller POS terminal 20’ in addition to the payment amount from the seller POS terminal 20 at the step S550. The ‘URI of seller 10’ is necessary for designating the receiver of the message for payment at the step S590, and the ‘ID of the seller POS terminal 20’ is to be included in the message for payment request so that the seller 10 can recognize the offline shop where the transaction has occurred.

Then, as shown in FIG. 6, the seller 10 requests payment by transmitting the payment request message received from the mobile wallet 130 at the step S590 to the SVC server 200 (S610).

The SVC server 200 accepts the request for payment received at the step S610 (S620), extracts the public key matching the IMSI of the buyer recorded in the message requesting the payment from the DB 220, and decodes the encoded amount of money (S630).

The step S630 also applies to the authentication procedure of the buyer. This is because, if the decoding at the step S630 were successful, it could be considered that the encoding had been performed using a fair private key, however, if the decoding were not successful, the encoding could not be considered to had been done with a fair private key.

If the decoding at the step S630 were successful, the SVC server 200 checks the balance, payment limit and term of validity of the buyer, and if they are all right, settles the payment (S640). The settlement at the step S640 is carried out by deducting the amount from the balance of the buyer in the DB 220 and adding the amount to the account of the seller 10.

Then, the SVC server 200 sends a message notifying completion of payment settlement to the mobile wallet 130 and seller (S650, S660). Then, the seller 10 sends the message notifying the settlement received at the step S660 to the seller POS terminal 20 (S670).

8. Mobile SVC Online Settlement

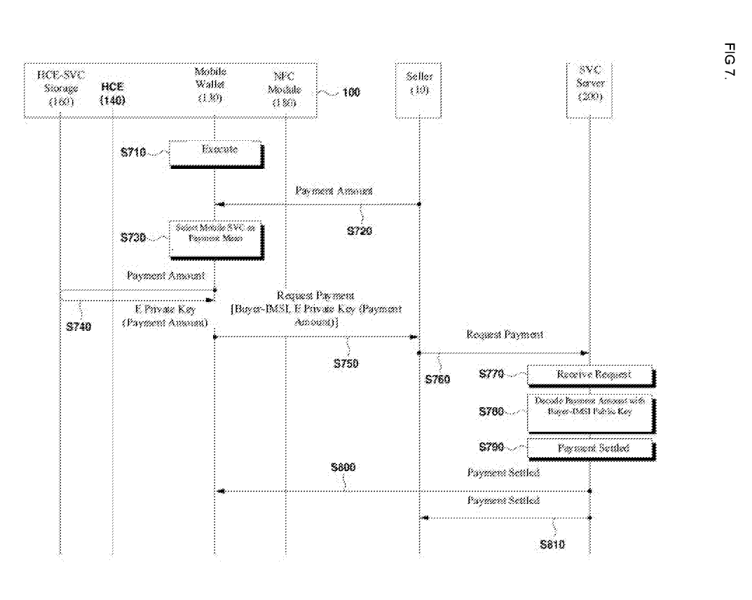

The procedure of online settlement using a mobile SVC issued to a mobile terminal 100 is described in detail below by referring to FIG. 7. FIG. 7 is a flow chart showing the procedure of online settlement using a mobile SVC.

As shown in FIG. 7, the mobile wallet 130 is executed automatically or manually (S710) to receive payment amount from a seller 10 (S720).

In the case of a mobile shopping using a mobile terminal 100, the mobile wallet 130 is started automatically by a mobile shopping application at the settlement phase of the mobile shopping, in the step S710. In the case of an Internet shopping using a PC (not shown), in the step S710, the mobile wallet 130 is executed by a user (hereinafter, “buyer”) manually.

Then, the buyer confirms the payment amount notified from the seller 100 via the mobile wallet 130 and selects the mobile SVC as a means of payment (S730).

Then, the mobile wallet 130 encodes the payment amount using the private key stored in the HCE-SVC storage 160 via the HCE unit 140 (S740). Then, the mobile wallet 130 sends a message requesting payment including the encoded payment amount and the buyer's IMSI to the seller 10 via the communication unit 110 (S750).

The seller 10 requests payment by transmitting the payment request message received from the mobile wallet 130 at the step S750 to the SVC server 200 (S760).

The SVC server 200 accepts the request for payment received at the step S760 (S770), extracts the public key matching the IMSI of the buyer recorded in the message requesting the payment from the DB 220, and decodes the encoded amount of money (S780).

If the decoding at the step S780 were successful, the SVC server 200 checks the balance, payment limit and term of validity of the buyer, and if they are all right, settles the payment (S790).

Then, the SVC server 200 sends a message notifying completion of payment settlement to the mobile wallet 130 and seller (S800, S810).

9. Modified Embodiments

The procedures of safely storing a mobile SVC using HCE, and transferring or paying off online or offline transactions with the balance of the mobile SVC are described above referring to preferred embodiments.

In the steps S370 through S390 in FIG. 3, it was assumed that the mobile terminal 100 stores the key pair received from the SVC server 200 as it is in the HCE-SVC 160. While the HCE-SVC 160 is a safe storage, the key pair can be encoded by password based encryption (PBE) before storing.

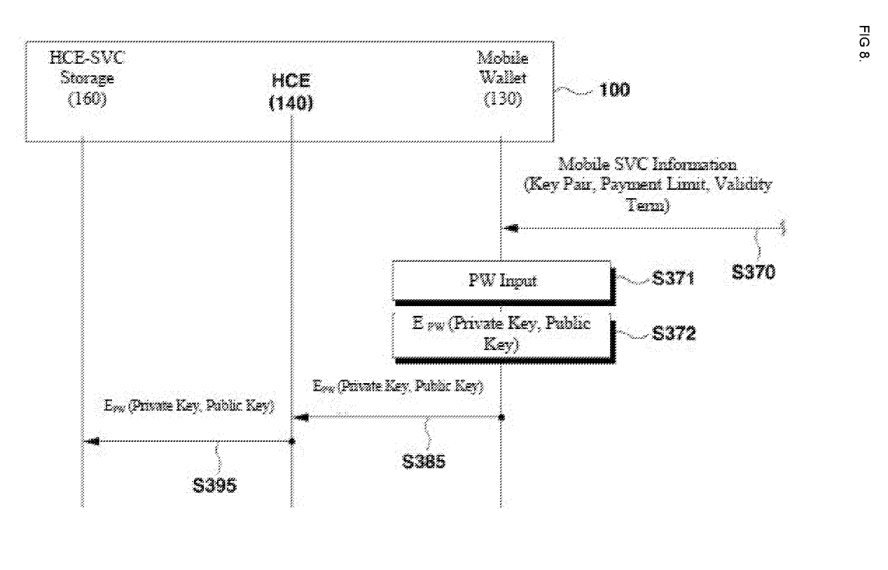

That is, as shown in FIG. 8, the mobile wallet 130 receiving mobile SVC information from the SVC server 200, receives password from a user (S371), encodes the public key and private key constituting a key pair using the password (S372), and stores the keys in the HCE-SVC storage 160 via the HCE unit 140 (S385, S395).

In this case wherein the key pair which is the core information of the mobile SVC was encrypted with a password, the step of decoding the private key using the password must be included additionally in the step S430 of FIG. 4, S580 of FIGS. 5, and S740 of FIG. 7, when using the mobile SVC.

It would be obvious that the password can be provided by a user when necessary, e.g., step S371 of FIG. 8, or at logging-in or initial execution procedure of the mobile wallet 130 according to the implementation of the embodiment.

Further, it is preferred that the password be changed on a periodic basis for security.

The key pair received from the SVC server 200 may be stored in a storage other than the memory 150. For example, the key pair can be stored in a separate security memory based on TEE (Trusted Execution Environment) if it is provided in the mobile terminal 100.

In addition, the IMSI which is an example of information for specifying or recognizing a user can be substituted by other information without departing from the technical spirit of the present invention.

In the above embodiment, it was assumed that the payment amount is encoded using a private key in the process of mobile SVC settlement, this is an exemplary configuration and can be implemented in various alternative ways. That is, the technical spirit of the present invention can be applied to the encoding of other information for settlement.

In addition, the above embodiment assumed that the HCE-SVC storage 160 stores a key pair (private key plus public key), an implementation where a private key only is stored would be also possible. In this case, the mobile wallet 130 can acquire a public key from the SVC server 200.

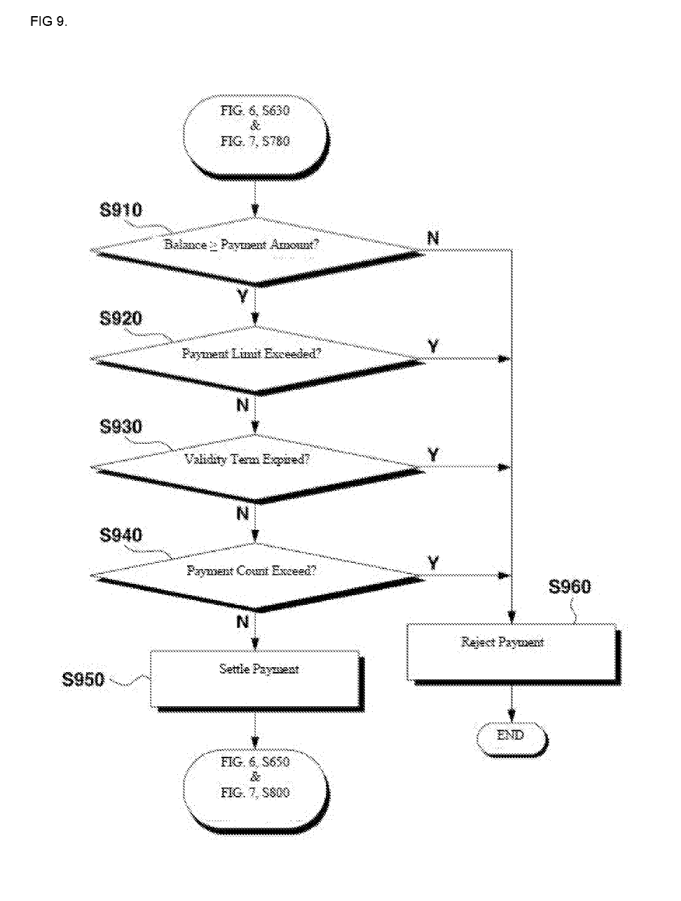

In the steps S640 of FIGS. 6 and S790 of FIG. 7, it was assumed that the payment limit and term of validity were applied as the limitations for the settlement, the count of payment can be added as another limitation. This method is described in detail below by referring to FIG. 9.

As shown in FIG. 9, the SVC server 200 determines whether the balance of the buyer (balance of the mobile SVC) is more than the amount of payment (S910). In the step S910, if it is judged that the balance is less than the amount of payment (S910-N), the SVC server 200 rejects the request for settlement (S960).

If the balance of the buyer us more than the payment amount (S910-Y), the SVC server 200 determines whether the mobile SVC is subject to any one of the conditions of limitation (S920 through S940). More particularly, if the mobile SVC exceeds the payment limit (S920-Y), if the term of validity was expired (S930-Y), or the count of the request for settlement exceeds the limit (S940-Y), the SVC server 200 rejects the request for settlement (S960).

The payment limit of the step S920 can include at least one of: limit of payment amount per transaction; limit of payment amount per day; and limit of total payment amount.

If no limitation is relevant (S920-N, S930-N & S940-N), the SVC server 200 deducts the payment amount from the balance of the buyer, and transfers the amount to the account of the seller to settle the transaction (S950).

The SVC is a kind of mobile cards that can store or charged with monetary value. As such, the SVC can be any other types of mobile cards, for example, stored value account (SVA) cards, prepaid cards, gift cards, traffic cards, both signed and unsigned.

In addition, it would be obvious that the technical spirit of the present invention can also be applied to the recording media which can be read with a computer system installed with a software program enabling the implementation of the device and method in accordance with an embodiment of the present invention. In addition, the technical spirit in accordance with the embodiments of the present invention can also be implemented is a coded-form written in recording media which can be read with a computer system. The recording media readable with a computer system can be any data storage media that can store data and can be read with a computer system. For example, the recording media readable with a computer system can be ROM, RAM, CD-ROM, magnetic tape, floppy discs, optical discs, hard disc drives, etc. In addition, the code or software programs which are readable with a computer system stored in a recording medium readable with a computer system can be transmitted over a computer network.

The scope of the present invention is not limited to the preferable embodiment set forth and described above. Various modifications and additions can be made by those skilled in the pertinent art without departing from the scope of the present invention. Therefore, it will be understood that the appended claims are intended to cover all such modifications and embodiments

What is claimed is:

1. A method for mobile card service comprising the steps of: receiving a mobile card information for ‘storing monetary value’, and storing the mobile card information in a storage device of a mobile terminal using a card emulation functionality provided by an Operating System (OS) of the mobile terminal.

2. A method for mobile card service in accordance with claim 1, wherein the card emulation function is characterized by being provided by the OS of the mobile terminal without a physical secure element (SE).

3. A method for mobile card service in accordance with claim 1, wherein the mobile card information is characterized by including at least one of a private key and public key necessary for using the mobile card.

4. A method for mobile card service in accordance with claim 3, wherein the private key and public key are characterized by being generated using user information.

5. A method for mobile card service in accordance with claim 4, wherein the user information is characterized by being stored in the SE of the mobile terminal.

6. A method for mobile card service ov claim 3, wherein the private key and the public key included in the mobile card information are generated by a mobile card server which is characterized by keeping the public key but not the private key.

7. A method for mobile card service in accordance with claim 1, wherein the method is characterized by further comprising a step of requesting use of the mobile card using the mobile card information stored in the memory device of the mobile terminal with the card emulation functionality provided by the OS of the mobile terminal.

8. A method for mobile card service in accordance with claim 7, wherein the use of the mobile card is characterized by including at least one of transferring a whole or a portion of a balance of the mobile card to another user and mobile payment with the balance of the mobile card.

9. A method for mobile card service in accordance with claim 1, wherein the storage step is characterized by encrypting and storing the mobile card information.

10. A method for mobile card service in accordance with claim 9, wherein the storage step is characterized by encrypting the mobile card information using a password entered by the user.

11. A method for mobile card service in accordance with claim 1, wherein the mobile card include at least one of a mobile stored value card (SVC), a mobile stored value account (SVA) card, a mobile prepaid card, a mobile gift card, and a mobile traffic card.

12. A mobile terminal characterized by comprising: a communication unit receiving a ‘mobile card information which can store monetary value’, a storage device for storing a mobile card information; and a processor for saving the mobile card information received via the communication unit in the storage device using a card emulation functionality provided by an operating system (OS) of a mobile terminal.

13. A method for mobile card service characterized by comprising the step of: acquiring a mobile card information for storing a monetary value stored in the storage device of the mobile terminal using the card emulation functionality provided by the OS of the mobile terminal; and requesting a use of the mobile card using the mobile card information acquired in the acquiring step.

14. A method for mobile card service in accordance with claim 13, wherein the mobile card information includes a private key, and the step of requesting use of the mobile card requests use of the mobile card while transferring a payment information encoded with the private key.

15. A method for mobile card service in accordance with claim 14, wherein the use of the mobile card is characterized by including at least one of transferring a whole or a portion of a balance of the mobile card to another user and mobile payment with the balance of the mobile card.

16. A method for mobile card service comprising the steps of: generating a mobile card information for ‘storing a monetary value’, and transferring the mobile card information generated in the above generation step; wherein the mobile terminal saves the mobile card information in the storage device of the mobile terminal using the card emulation functionality provided by the OS of the mobile terminal.

17. A method for mobile card service in accordance with claim 16, characterized by comprising a step of storing only the public key of the private key and public key.

18. A method for mobile card service comprising the steps of: receiving a request for using the mobile card while receiving from the user terminal the information encoded with the private key; decoding the encoded information using the public key; and processing the use of the mobile card using the decoded information.

19. A mobile card server comprising: an authorization unit for generating a ‘mobile card information for storing a monetary value’; and an issuing unit for transmitting the mobile card information generated in the authorization unit; wherein the mobile terminal is characterized by saving the mobile card information in the storage device of the mobile terminal using the card emulation functionality provided by the OS of the mobile terminal.

20. A method for mobile card service comprising the steps of: receiving a request for payment including the payment information generated by using the ‘mobile card information for storing a monetary value’; decoding the payment information included in the payment request; and processing the settlement of the decoded payment information.

21. A method for mobile card service in accordance with claim 20, wherein the mobile card information includes a private key, the information for payment is encoded with the private key, and the decoding step decodes the information for payment using a public key which forms a pair with the private key.

22. A method for mobile card service in accordance with claim 20, wherein the payment processing step is characterized by comprising the steps of: determining whether the balance of the mobile card is equal to or greater than the amount of payment indicated in the information for payment; if the balance is more than the amount of payment, checking the limitations imposed on the mobile card; and if the mobile card is not subject to above limitation, deducting the amount of payment from the balance.

23. A method for mobile card service in accordance with claim 23, wherein the limitations can include at least one of the maximum limit of payment, validity term and count of payment of the mobile card.
